(19) United States
(12) Patent Application Publication
(10) Pub. No.: US 2017/0339613 A1
(43) Pub. Date: Nov. 23, 2017

(54) BASE STATION, APPARATUS, AND RADIO TERMINAL

(71) Applicant: KYOCERA CORPORATION, Kyoto (JP)

(72) Inventors: Masato FUJISHIRO, Yokohama-shi, Kanagawa (JP); Katsuhiro MITSUI, Kawasaki-shi, Kanagawa (JP); David COMSTOCK, San Diego, CA (US)

(73) Assignee: KYOCERA CORPORATION, Kyoto (JP)

(21) Appl. No.: 15/523,837

(22) PCT Filed: Nov. 5, 2015
(86) PCT No.: PCT/JP2015/081215

§ 371 Date: May 2, 2017

Related U.S. Application Data
(60) Provisional application No. 62/076,759, filed on Nov. 7, 2014.

(51) Int. Cl. H04W 36/14; H04W 36/00; H04W 24/02

(52) U.S. Cl. CPC H04W 36/14; H04W 36/0094; H04W 24/02

(57) ABSTRACT

A base station according to an embodiment is provided in a mobile communication network. The base station includes: a network communication unit configured to receive, from an evolved packet core (EPC), first switching information indicating that a radio terminal switches a communication path with the EPC from the mobile communication network to a wireless LAN; and a controller configured to start measurement of a staying time in which the radio terminal stays in the wireless LAN, in response to reception of the first switching information.

### CROSS REFERENCE

This application claims the benefit of U.S. Provisional Application No. 62/076,759 filed Nov. 7, 2014, the entire contents of which are incorporated herein by reference.

### TECHNICAL FIELD

The present invention relates to a base station, an apparatus, and a radio terminal used in a system in which a process of switching a communication path between a mobile communication network and a wireless LAN is performed.

### BACKGROUND ART

In the past, a technique in which a radio terminal switches a communication path between a mobile communication network and a wireless LAN has been proposed (for example, see Non-Patent Literature 1). A communication path is established between a radio terminal and a core network, and switching in access point name (APN) units (or bearer units) can be performed.

The switching of the communication path is performed by network selection of selecting a network and traffic steering of routing traffic. In long term evolution (LTE), a mobile communication network is referred to as an evolved universal terrestrial radio access network (E-UTRAN), and a core network is referred to as an evolved packet core (EPC).

The radio terminal determines whether or not switching is performed on the basis of whether or not first information on a mobile communication network side satisfies a first condition and whether or not second information on a wireless LAN side satisfies a second condition. The first information is, for example, a measurement result (RSRPmeas) of a reference signal received power (RSRP) and a measurement result (RSRQmeas) of the reference signal received quality (RSRQ). The second information is, for example, a wireless LAN channel utilization value, a wireless LAN backhaul value, a received signal strength indicator (RSSI).

Determination parameters for determining whether or not the communication path between the mobile communication network and the wireless LAN is performed are notified from a base station provided in a mobile communication network to the radio terminal. As the determination parameters, there are individual parameters which are notified to the radio terminal and broadcast parameters which are broadcast to the radio terminal.

### CITATION LIST

### Non Patent Literature

Non-Patent Literature 1: TS36.304 V12.1.0

### SUMMARY OF INVENTION

A base station according to an embodiment is provided in a mobile communication network. The base station includes: a network communication unit configured to receive, from an evolved packet core (EPC), first switching information indicating that a radio terminal switches a communication path with the EPC from the mobile communication network to a wireless LAN; and a controller configured to start measurement of a staying time in which the radio terminal stays in the wireless LAN, in response to reception of the first switching information.

An apparatus according to an embodiment constitutes an evolved packet core (EPC). The apparatus includes: a controller configured to start measurement of a staying time in which a radio terminal stays in a wireless LAN when the controller detects that the radio terminal switches a communication path with the EPC from a mobile communication network to the wireless LAN.

A radio terminal according to an embodiment is configured to transmit, to a base station constituting a mobile communication network, switching information indicating that a communication path with an evolved packet core (EPC) is switched from a wireless LAN to the mobile communication network. The switching information is included in a message for establishing an RRC connection between the radio terminal and the base station or a message for reconfiguring an RRC connection between the radio terminal and the base station.

### BRIEF DESCRIPTION OF DRAWINGS

FIG. 1 is a diagram illustrating a communication system according to first to third embodiments.

FIG. 2 is a diagram illustrating a switching process according to the first to third embodiments.

FIG. 3 is a block diagram illustrating a configuration of a UE (radio terminal) according to the first to third embodiments.

FIG. 4 is a block diagram illustrating a configuration of an eNB (base station) according to the first to third embodiments.

FIG. 5 is a block diagram illustrating a configuration of a P-GW (core network apparatus) according to the first to third embodiments.

FIG. 6 is a sequence diagram illustrating an operation according to the first embodiment.

FIG. 7 is a sequence diagram illustrating an operation according to the second embodiment.

### DESCRIPTION OF EMBODIMENTS

[Overview of the Embodiment]

In a background technique, there is concern about a phenomenon that a process in which a radio terminal switches a communication path from a mobile communication network to a wireless LAN (an offload process) and a process in which the same radio terminal switches the communication path from the wireless LAN to the mobile communication network (a reoffload process) are repeated (hereafter, a “ping-pong phenomenon”).

From a point of view of such a ping-pong phenomenon, it is desirable that the base station optimize the determination parameters. However, in a current mechanism, information for optimizing the determination parameters is insufficient, and the determination parameters are unable to be appropriately optimized.

In this regard, according to an embodiment, provided are a base station, an apparatus, and a radio terminal, which are capable of acquiring information for optimizing the determination parameters.

A base station according to an embodiment is provided in a mobile communication network. The base station includes: a network communication unit configured to receive, from an evolved packet core (EPC), first switching information indicating that a radio terminal switches a communication path with the EPC from the mobile communication network to a wireless LAN; and a controller configured to start measurement of a staying time in which the radio terminal stays in the wireless LAN, in response to reception of the first switching information.

The first switching information may be included in a first message transmitted from the EPC. The first message may be a message for giving an instruction to release one or more bearers established between the radio terminal and the EPC via the base station.

The network communication unit may be configured to receive, from the EPC, second switching information indicating that the radio terminal switches the communication path from the wireless LAN to the mobile communication network. The controller may be configured to end the measurement of the staying time in response to reception of the second switching information.

The second switching information may be included in a second message transmitted from the EPC. The second message may be a message for requesting establishment of one or more bearers between the radio terminal and the EPC via the base station.

The controller may be configured to hold an identifier associated with the radio terminal after the radio terminal switches the communication path to the wireless LAN. The second message may include an identifier associated with the radio terminal. The controller may be configured to detect that the radio terminal switches the communication path to the mobile communication network on the basis of the held identifier and the identifier included in the second message.

The base station may further include a radio communication unit configured to receive, from the radio terminal, second switching information indicating that the radio terminal switches the communication path from the wireless LAN to the mobile communication network. The controller may be configured to end the measurement of the staying time in response to reception of the second switching information.

The second switching information may be included in a third message transmitted from the radio terminal. The third message may be a message for establishing an RRC connection between the radio terminal and the base station or a message for reconfiguring an RRC connection between the radio terminal and the base station.

The controller may be configured to hold an identifier associated with the radio terminal after the radio terminal switches the communication path to the wireless LAN. The third message may include an identifier associated with the radio terminal. The controller may be configured to detect that the radio terminal switches the communication path to the mobile communication network on the basis of the held identifier and the identifier included in the third message.

The network communication unit may be configured to receive a threshold value from the EPC. The controller may be configured to compare the measured staying time with the threshold value, and to decide parameters when the staying time is less than the threshold value. The parameters may be parameters used for determining whether or not the radio terminal switches the communication path from the mobile communication network to the wireless LAN.

An apparatus according to an embodiment constitutes an evolved packet core (EPC). The apparatus includes: a controller configured to start measurement of a staying time in which a radio terminal stays in a wireless LAN when the controller detects that the radio terminal switches a communication path with the EPC from a mobile communication network to the wireless LAN.

When the controller detects that the radio terminal switches the communication path from the wireless LAN to the mobile communication network, the controller may be configured to end the measurement of the staying time, and to give a notification of information based on the staying time to a base station constituting the mobile communication network.

A radio terminal according to an embodiment is configured to transmit, to a base station constituting a mobile communication network, switching information indicating that a communication path with an evolved packet core (EPC) is switched from a wireless LAN to the mobile communication network. The switching information is included in a message for establishing an RRC connection between the radio terminal and the base station or a message for reconfiguring an RRC connection between the radio terminal and the base station.

### First Embodiment

(Configuration of Communication System)

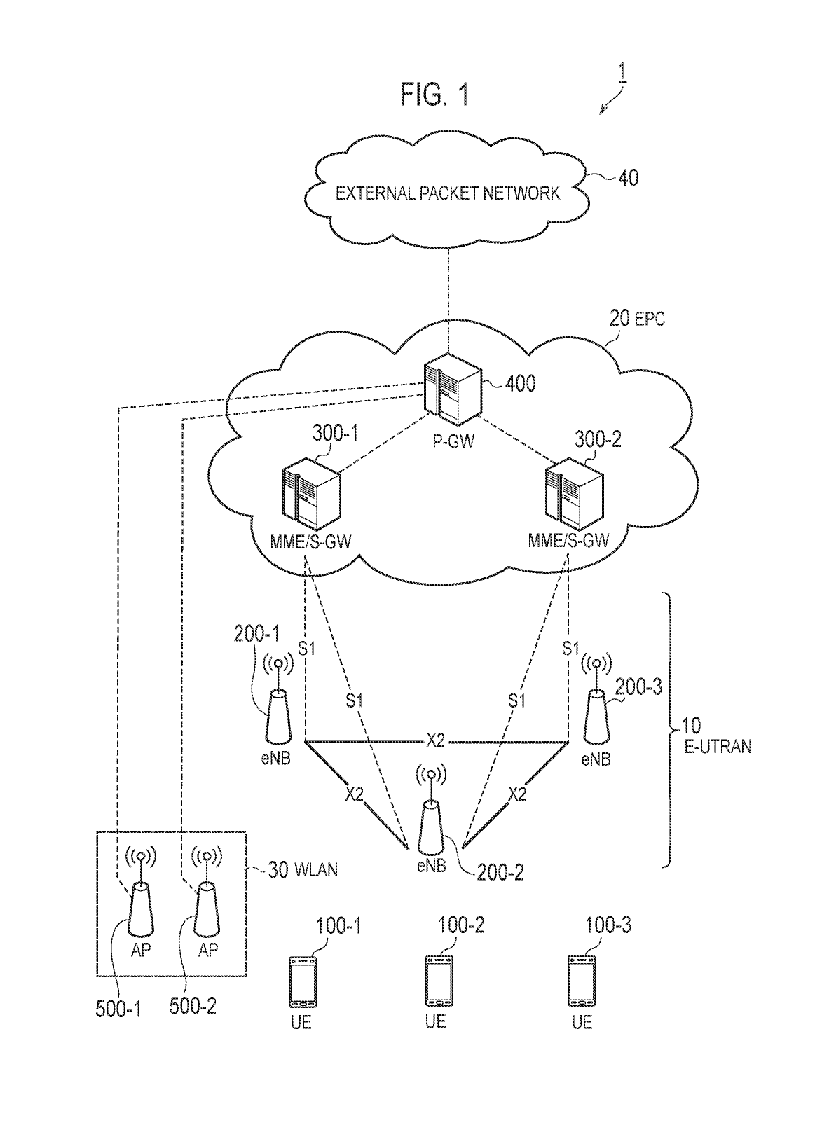

A communication system according to a first embodiment will be described below. FIG. 1 is a diagram illustrating a communication system 1 according to the first embodiment. In the first embodiment, LTE is employed as a mobile communication scheme.

As illustrated in FIG. 1, the communication system 1 includes an E-UTRAN 10, an EPC 20, a wireless LAN (WLAN) 30, an external packet network 40, and a user equipment (UE) 100. The UE 100 corresponds to a radio terminal. In the first embodiment, the E-UTRAN 10 corresponds to the mobile communication network. Further, the EPC 20 corresponds to the core network.

The E-UTRAN 10 includes an evolved Node-B (eNB 200). In the first embodiment, the eNB 200 corresponds to the base station provided in the mobile communication network. The eNB 200 manages one or more cells. A cell may be regarded as a term indicating a geographical area or may be regarded as a function of performing radio communication with the UE 100. The eNBs 200 are connected to each other via an X 2 interface. A configuration of the eNB 200 will be described later.

The EPC 20 includes a mobility management entity (MME)/serving-gateway (S-GW) 300 and a packet data network gateway (P-GW) 400. The MME performs various kinds of mobility control such as location registration and handover of the UE 100. The S-GW performs control such that user data is relayed between the P-GW 400 and the eNB 200. The MME/S-GW 300 is connected to the eNB 200 via an S1 interface.

The P-GW 400 has a function as a connection point with the external packet network 40 and a function as a connection point with the WLAN 30. The P-GW 400 performs the allocation of an IP address to the UE 100, authentication at the time of establishing the bearer, and the like. Further, the P-GW 400 performs control such that user data is relayed from the external packet network 40 or to the external packet network 40. In the first embodiment, the P-GW 400 corresponds to a core network apparatus provided in the core network.

The external packet network 40 is disposed outside the EPC 20 and is a packet network such as the Internet and/or an operator service network.

The WLAN 30 includes an access point (AP) 500. The AP 500 is configured in conformity with, for example, an IEEE 802.11 standard. The AP 500 performs radio communication with the UE 100 at a frequency band different from a frequency band of LTE communication (for example, an unlicensed band).

The UE 100 is a terminal such as a mobile phone, a tablet, or a card type terminal. In addition to the function of performing radio communication with the eNB 200, the UE 100 has a function of performing radio communication with the AP 500. A configuration of the UE 100 will be described later.

An enhanced packet data gateway (ePDG) may be disposed between the AP 500 and the P-GW 400. The ePDG is an end point on the EPC 20 side for establishing an IPSec tunnel with the UE 100 in order to accommodate a WLAN that is not reliable in terms of security. Further, a direct interface may be disposed between the eNB 200 and the AP 500.

(Overview of Switching Process)

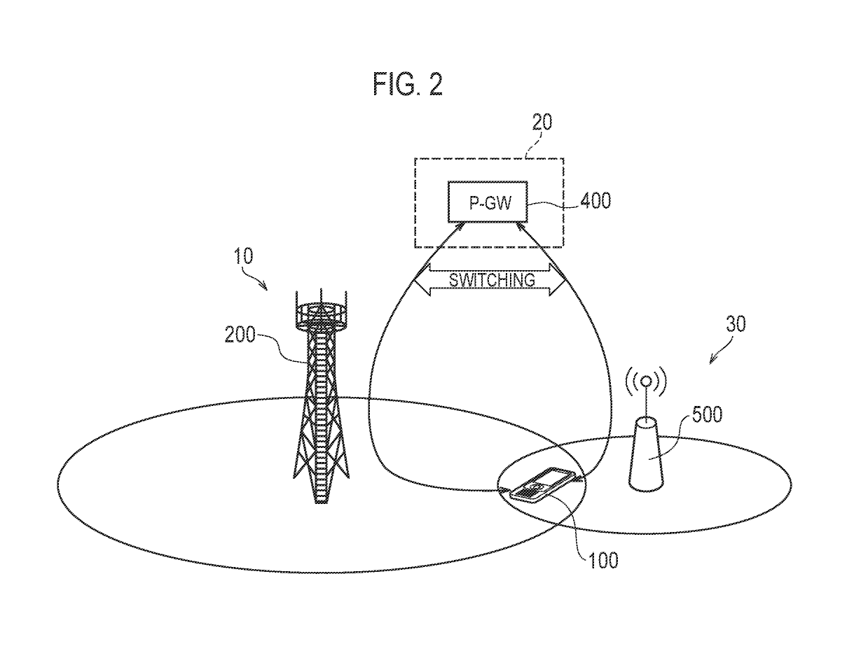

A method in which the UE 100 performs a switching process (for example, network selection and traffic steering) for switching the communication path between the E-UTRAN 10 and the WLAN 50 will be described. FIG. 2 is a diagram illustrating the switching process according to the first embodiment.

As illustrated in FIG. 2, the eNB 200 provides a mobile communication service of LTE in its own coverage area. The coverage area of eNB 200 is configured with one or more cells. The AP 500 provides a wireless LAN service in its own coverage area. A part or all of the coverage area of the AP 500 overlaps the coverage area of the eNB 200.

The UE 100 in an RRC connected state or an RRC idle state performs the switching process to select one of the E-UTRAN 10 and the WLAN 50 as a radio access network in which transmission and reception of traffic are performed. In detail, when the state in which the first information on the E-UTRAN 10 side satisfies the first condition, and the second information on the WLAN 50 side satisfies the second condition is continued for a predetermined period, the switching process (for example, network selection and traffic steering) is performed.

A communication path in which transmission and reception of traffic are performed is established between the UE 100 and the P-GW 400. In the first embodiment, the switching process includes both a process in which the UE 100 switches the communication path from the E-UTRAN 10 to the WLAN 50 and a process in which the UE 100 switches the communication path from the WLAN 50 to the E-UTRAN 10. The switching of the communication path is performed in APN units. Alternatively, the switching of the communication path may be performed in bearer units.

Here, the first information on the E-UTRAN 10 side includes, for example, a measurement result (RSRPmeas) of a signal level of a received signal (reference signal received power (RSRP)) and a measurement result (RSRQmeas) of a signal quality of a received signal (reference signal received quality (RSRQ)).

The second information on the WLAN 50 side includes, for example, a channel utilization value of the WLAN 50 (ChannelUtilizationWLAN), a downlink backhaul value of the WLAN 50 (BackhaulRateD1WLAN), an uplink backhaul value of the WLAN 50 (BackhaulRateU1WLAN), and a signal level of a received signal (a received signal strength indicator (RSSI).
Switching process from E-UTRAN 10 to WLAN 50

The first condition that the UE 100 switches the communication path from the E-UTRAN 10 to the WLAN 50 is, for example, that one of the following conditions (1a) or (1b) be satisfied. However, the first condition may be that both of the following conditions (1a) and (1b) be satisfied.
(1a) RSRPmeas<Thresh_{ServingOffloadWLAN,LowP}
(1b) RSRQmeas<Thresh_{ServingOffloadWLAN,LowQ}

“Thresh_{ServingOffloadWLAN,LowP}” and “Thresh_{ServingoffloadwLAN,LowQ}” are threshold values provided from the eNB 200 or predetermined threshold values.

The second condition that the UE 100 switches the communication path from the E-UTRAN 10 to the WLAN 50 is that, for example, all of the following conditions (1c) to (1f) be satisfied. However, the second condition may be that any one of the following conditions (1c) to (1f) be satisfied.
(1c) ChannelUtilizationWLAN<Thresh_{ChUtilWLAN,Low}
(1d) BackhaulRateD1WLAN>Thresh_{BackhRateDLWLAN,High}
(1e) BackhaulRateU1WLAN>Thresh_{BackhRateULWLAN,High}
(1f) RSSI>Thresh_{BEACONRSSI,High}

“Thresh_{ChUtilWLAN,Low},” “Thresh_{BackhRateDLWLAN,High},” “Thresh_{BackhRateULWLAN,High},” and “Thresh_{BEACONRSSI,High}” are threshold values provided from the eNB 200 or predetermined threshold values.
Switching process from WLAN 50 to E-UTRAN 10

The first condition that the UE 100 switches the communication path from the WLAN 50 to the E-UTRAN 10 is that, for example, the following conditions (2a) and (2b) be satisfied. However, the first condition may be that either of the following conditions (2a) or (2b) be satisfied.
(2a) RSRPmeas>Thresh_{ServingOffloadWLAN,HighP}
(2b) RSRQmeas>Thresh_{ServingOffloadWLAN,HighQ}

“Thresh_{ServingOffloadWLAN,HighP}” and “Thresh_{ServingOffloadWLAN,HighQ}” are threshold values provided from the eNB 200 or predetermined threshold values.

The second condition that the UE 100 switches the communication path from the WLAN 50 to the E-UTRAN 10 is, for example, that one of the following conditions (2c) to (2f) be satisfied. However, the second condition may be that all of the following conditions (2c) to (2f) be satisfied.
(2c) ChannelUtilizationWLAN>Thresh_{ChUtilWLAN,High}
(2d) BackhaulRateD1WLAN<Thresh_{BackhRateDLWLAN,Low}
(2e) BackhaulRateU1WLAN<Thresh_{BackhRateULWLAN,Low}
(2f) RSSI<Thresh_{BEACONRSSI,Low}

“Thresh_{ChUtilWLAN,High},” “Thresh_{BackhRateDLWLAN,Low},” “Thresh_{BackhRateULWLAN,Low},” and “Thresh_{BEACONRSSI,Low}” are threshold values provided from the eNB 200 or predetermined threshold values.

When the above-described threshold values are not provided, the UE 100 may omit acquisition (that is, reception or measurement) of information whose threshold value is not provided.

In the first embodiment, the various threshold values described above are examples of the determination parameters (for example, RAN assistance parameters) for determining whether or not the UE 100 performs the switching process of switching the communication path between the E-UTRAN 10 and the WLAN 50. In other words, the determination parameters include one or more values selected from “Thresh_{ServingOffloadWLAN,LowP},” “Thresh_{ServingOffloadWLAN,LowQ},” “Thresh_{ChUtilWLAN,Low},” “Thresh_{BackhRateDLWLAN,High},” “Thresh_{BackhRateULWLAN,High},” “Thresh_{BEACONRSSI,High},” “Thresh_{ServingOffloadWLAN,HighP},” “Thresh_{ServingOffloadWLAN,HighQ},” “Thresh_{ChUtilWLAN,High},” “Thresh_{BackhRateDLWLAN,Low},” “Thresh_{BackhRateULWLAN,Low},” and “Thresh_{BEACONRSSI,Low}.”

Further, the determination parameters may include a predetermined period (Tsteering_{WLAN}) in which the state in which the first condition or the second condition is satisfied is continued.

The determination parameters include individual parameters which are individually notified from the eNB 200 to the UE 100 and the broadcast parameters which are broadcast from the eNB 200 to the UE 100. The individual parameters are included in, for example, an RRC message (for example, RRC Connection Reconfiguration) which is transmitted from the eNB 200 to the UE 100. The broadcast parameters are included in, for example, an SIB (for example, WLAN-OffloadConfig-r12) which is broadcast from the eNB 200. It should be noted that, when the individual parameters are received in addition to the broadcast parameters, the UE 100 applies the individual parameters more preferentially than the broadcast parameters.

In the switching process, when the determination parameters are not appropriately configured, the ping-pong phenomenon that the process in which the UE 100 switches the communication path from the E-UTRAN 10 to the WLAN 30 (the offload process) and the process in which the same UE 100 switches the communication path from the WLAN 30 to the E-UTRAN 10 (the reoffload process) are repeated may occur.

(Configuration of Radio Terminal)

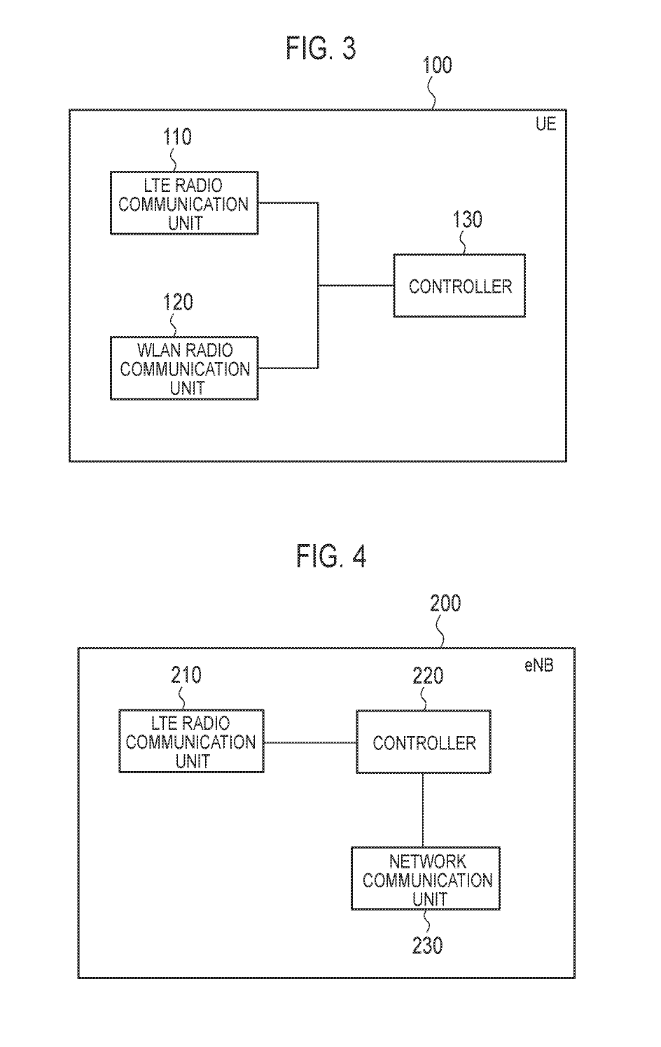

A configuration of the UE 100 (the radio terminal) according to the first embodiment will be described below. FIG. 3 is a block diagram illustrating a configuration of the UE 100 according to the first embodiment.

As illustrated in FIG. 3, the UE 100 includes an LTE radio communication unit 110, a WLAN radio communication unit 120, and a controller 130.

The LTE radio communication unit 110 has a function of performing radio communication with the eNB 200 and is configured with, for example, a radio transceiver. For example, the LTE radio communication unit 110 periodically receives the reference signal from the eNB 200. The LTE radio communication unit 110 periodically measures the signal level of the reference signal (RSRP) and the signal quality of the reference signal (RSRQ). The LTE radio communication unit 110 receives the individual parameters and the broadcast parameters from the eNB 200 as the determination parameters.

The WLAN radio communication unit 120 has a function of performing radio communication with the AP 500 and is configured with, for example, a radio transceiver. For example, the WLAN radio communication unit 120 receives a beacon or probe response from the AP 500. The beacon or probe response includes a BBS load information element, and the channel utilization value (ChannelUtilizationWLAN) of the WLAN 50 can be acquired from the BBS load information element.

The WLAN radio communication unit 120 receives a response (a generic advertisement service (GAS) response) which is transmitted from the AP 500 in response to a request (GAS request) with respect to the AP 500. The response (GAS response) includes the downlink backhaul value (BackhaulRateD1WLAN) of the WLAN 50 and the uplink backhaul value (BackhaulRateU1WLAN) of the WLAN 50. Such a query procedure is performed in accordance with an access network query protocol (ANQP) specified in Hotspot 2.0 of Wi-Fi alliance (WFA).

The WLAN radio communication unit 120 receives a signal from the AP 500. The WLAN radio communication unit 120 measures the signal level of the received signal (RSSI). The signal level of the received signal (RSSI) is the signal strength of the beacon or probe response.

The controller 130 is configured with a CPU (processor), a memory, and the like, and controls the UE 100. In detail, the controller 130 controls the LTE radio communication unit 110 and the WLAN radio communication unit 120. When the state in which the first information on the E-UTRAN 10 side satisfies the first condition, and the second information on the WLAN 50 side satisfies the second condition is continued for a predetermined period, the controller 130 performs the switching process for switching the communication path between the E-UTRAN 10 and the WLAN 50.

(Configuration of Base Station)

A configuration of the eNB 200 (the base station) according to the first embodiment will be described below. FIG. 4 is a block diagram illustrating a configuration of the eNB 200 according to the first embodiment.

As illustrated in FIG. 4, the eNB 200 includes an LTE radio communication unit 210, a controller 220, and a network communication unit 230.

The LTE radio communication unit 210 has a function of performing radio communication with the UE 100. For example, the LTE radio communication unit 210 periodically transmits the reference signal to the UE 100. The LTE radio communication unit 210 is configured with, for example, a radio transceiver.

The LTE radio communication unit 210 transmits the individual parameters and the broadcast parameters to the UE 100 as the determination parameters. As described above, the LTE radio communication unit 210 notifies the UE 100 of the individual parameters through the RRC message (for example, RRC Connection Reconfiguration), and notifies the UE 100 of the broadcast parameters through the SIB (for example, WLAN-OffloadConfig-r12).

The controller 220 is configured with a CPU (processor), a memory, and the like, and controls the eNB 200. In detail, the controller 220 controls the LTE radio communication unit 210 and the network communication unit 230. The memory constituting the controller 220 may function as a storage unit, or a memory constituting a storage unit may be provided separately from a memory constituting the controller 220.

The network communication unit 230 is connected to a neighbor base station via the X2 interface and is connected to the MME/S-GW via the S1 interface. The network communication unit 230 is used for communication performed on the X2 interface and communication performed on the S1 interface.

In the eNB 200 having the above configuration, the network communication unit 230 transmits first switching information (steer from LTE to WLAN) indicating that the UE 100 having the communication path with the EPC 20 via the eNB 200 switches the communication path from the eNB 200 to the WLAN 50 from the EPC 20. In the first embodiment, the first switching information is included in a first message transmitted from the EPC 20. The first message is a message (E-RAB Release Command) for giving an instruction to release one or more bearers (E-UTRAN Radio Access Bearers (E-RABs)) established between the UE 100 and the EPC 20 via the eNB 200. The E-RAB is configured with an S1 bearer between the eNB 200 and the S-GW 300 and the radio bearer between the eNB 200 and the UE 100.

In response to the reception of the first switching information, the controller 220 starts measurement of a staying time at which the UE 100 stays in the WLAN 50. In detail, the controller 220 activates a WLAN stay timer when the first switching information is received.

Further, the network communication unit 230 receives second switching information (steer from WLAN to LTE) indicating that the UE 100 switches the communication path from the WLAN 50 to the E-UTRAN 10 from the EPC 20. In the first embodiment, the second switching information is included in a second message transmitted from the EPC 20. The second message is a message (E-RAB Setup Request) for requesting establishment of one or more bearer (E-RAB) between the UE 100 and the EPC 20 via the eNB 200.

In response to the reception of the second switching information, the controller 220 ends the measurement of the staying time. In detail, when the second switching information is received, the controller 220 stops the WLAN stay timer and acquires a value of the WLAN stay timer as the staying time.

In the first embodiment, the controller 220 holds an identifier associated with the UE 100 after the UE 100 switches the communication path to the WLAN 50. The second message (E-RAB Release Command) includes the identifier associated with the UE 100. The controller 220 detects that the UE 100 has switched the communication path to its own eNB 200 on the basis of the held identifier and the identifier included in the second message. In detail, when the held identifiers and the identifiers included in the second message are identical to each other, the controller 220 regards that the UE 100 has switched the communication path to the eNB 200 again after the UE 100 has switched the communication path to the WLAN 30.

In the first embodiment, the identifier associated with the UE 100 is a tunnel endpoint identifier (TEID). However, an identifier other than the TEID may be used. The TEID is an identifier identifying an IP tunnel between the eNB 200 and the EPC 20. The IP tunnel is allocated for each UE 100. The TEID is added to the user data which is transmitted and received between the eNB 200 and the EPC 20.

In the first embodiment, the network communication unit 230 receives a threshold value (Ping-pong threshold) from the EPC 20. The threshold value is a threshold value for determining whether or not the ping-pong phenomenon occurs. The threshold value (Ping-pong threshold) may be set in the controller 220 in advance.

The controller 220 compares the measured staying time with the threshold value and decides parameters when the staying time is less than the threshold value. The parameters are parameters (determination parameters) used for determining whether or not the UE 100 switches the communication path from the E-UTRAN 10 to the WLAN 50.

In detail, when the staying time is less than the threshold value, the controller 220 determines that the ping-pong phenomenon has occurred and optimizes the determination parameters. For example, the eNB 200 performs a setting of decreasing the threshold value for the first information on the E-UTRAN 10 side. Alternatively, the eNB 200-1 performs a setting of increasing the threshold value for the second information on the WLAN 50 side. In other words, the eNB 200 sets the determination parameters such that offload process to the WLAN 50 is hardly performed.

Alternatively, the controller 220 optimizes a timer (a Tsteering WLAN timer) indicating a predetermined period (Tsteering_{WLAN}). The timer is a timer that measures a minimum time (Tsteering_{WLAN}) in which the state in which the first information satisfies the first condition or the state in which the second information satisfies the second condition should be continued in order to perform the offload process or the reoffload process. For example, the eNB 200 sets the timer to have a value longer than a currently set value.

(Configuration of Core Network Apparatus)

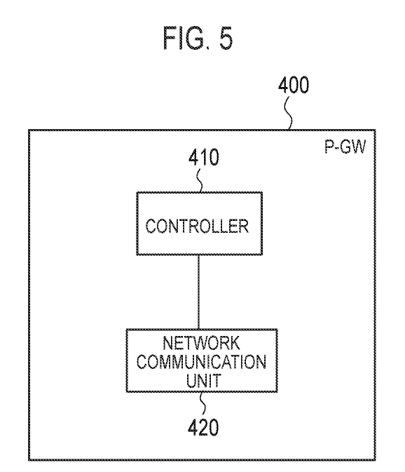

A configuration of the P-GW 400 (the core network apparatus) according to the first embodiment will be described below. FIG. 5 is a block diagram illustrating a configuration of the P-GW 400 according to the first embodiment.

As illustrated in FIG. 5, the P-GW 400 includes a controller 410 and a network communication unit 420.

The controller 410 is configured with a CPU (processor), a memory, and the like, and controls the P-GW 400. In detail, the controller 410 controls the network communication unit 420. The memory constituting the controller 410 may function as a storage unit, or a memory constituting the storage unit may be provided separately from the memory constituting the controller 410.

The network communication unit 420 is connected to the MME/S-GW 300, the AP 500, and the external packet network 40. The network communication unit 420 is used for communication with the MME/S-GW 300, the AP 500, and the external packet network 40. Further, the network communication unit 420 may be connected to the eNB 200 via a predetermined interface.

In the P-GW 400 having the above configuration, the controller 410 detects that the UE 100 having the communication path with the EPC 20 via the eNB 200 switches the communication path from the eNB 200 to the WLAN 50 (that is, the offload process). For example, the controller 410 detects the offload process on the basis of the flow of the user data of the UE 100. Alternatively, the controller 410 may detect the offload process on the basis of a notification given from the UE 100.

When the offload process is detected, the network communication unit 420 transmits the first message (E-RAB Release Command) including the first switching information (steer from LTE to WLAN) to the eNB 200. The network communication unit 420 may transmit the first message to the eNB 200 via the MME/S-GW 300.

In the first embodiment, the controller 410 holds the identifier associated with the UE 100 after the UE 100 switches the communication path to the WLAN 50. In the first embodiment, the identifier associated with the UE 100 is the tunnel endpoint identifier (TEID). However, an identifier other than the TEID may be used.

Further, the controller 410 detects that the UE 100 switches the communication path from the WLAN 50 to the E-UTRAN 10 (that is, the reoffload process). For example, the controller 410 detects the reoffload process on the basis of the flow of the user data of the UE 100. Alternatively, the controller 410 may detect the reoffload process on the basis of the notification given from the UE 100. When the reoffload process is detected, the controller 410 allocates the held TEID for the UE 100.

Further, when the reoffload process is detected, the network communication unit 420 transmits the second message (E-RAB Setup Request) including the second switching information (steer from WLAN to LTE) to the eNB 200. The network communication unit 420 may transmit the second message to the eNB 200 via the MME/S-GW 300. The second message includes the TEID allocated for the UE 100.

### (Operation Sequence According to First Embodiment)

Next, an operation sequence according to the first embodiment will be described. In detail, an operation of acquiring information for optimizing the determination parameters in order to suppress the ping-pong phenomenon will be described.

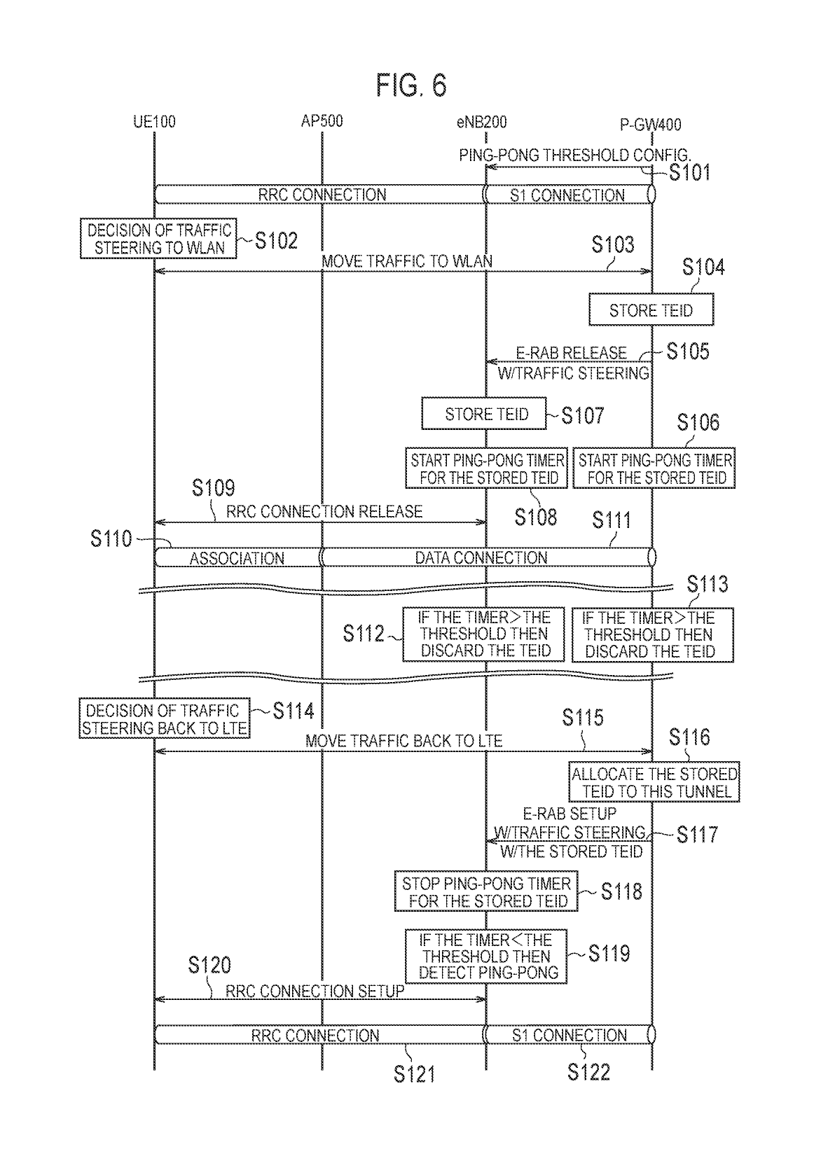

FIG. 6 is a sequence diagram illustrating an operation according to the first embodiment. In an initial state of the present sequence, the communication path is established between the UE 100 and the P-GW 400. In detail, one or more bearers (E-RABs) are established between the UE 100 and the EPC 20 via the eNB 200. Further, the RRC connection (and the radio bearer) is established between the UE 100 and the eNB 200, and the S1 connection (the S1 bearer) is established between the eNB 200 and the EPC 20.

As illustrated in FIG. 6, prior to the present sequence, the P-GW 400 sets the threshold value (Ping-pong threshold) in the eNB 200 (step S101). The threshold value (Ping-pong threshold) may be set in the eNB 200 from operations administration maintenance (OAM) which operates and manages the network.

In step S102, the UE 100 decides to perform the offload process from the eNB 200 to the AP 500.

In step S103, the UE 100 performs the offload process from the eNB 200 to the AP 500. The P-GW 400 detects the offload process.

In step S104, the P-GW 400 holds the TEID allocated to the IP tunnel or a GPRS tunnel protocol (GTP) tunnel of the UE 100 before the offload process.

In step S105, the P-GW 400 (or the MME/S-GW 300) transmits the first message (E-RAB Release Command) including the first switching information (steer from LTE to WLAN) to the eNB 200. The eNB 200 receives the first message. Accordingly, the E-RAB (the radio bearer and the S1 bearer) are released.

In step S106, the P-GW 400 activates the WLAN stay timer. In the first embodiment, the WLAN stay timer of the P-GW 400 is used to specify a period during which the P-GW 400 should hold the TEID.

In step S107, the eNB 200 holds the TEID allocated to the IP tunnel or the GTP tunnel of the UE 100 before the offload process.

In step S108, the eNB 200 activates the WLAN stay timer. The WLAN stay timer is associated with the TEID held in step S107.

In step S109, the UE 100 releases the RRC connection with the eNB 200. In detail, when an RRC release message is transmitted from the eNB 200 to the UE 100, the UE 100 releases the RRC connection with the eNB 200.

In step S110, the UE 100 establishes a connection (WLAN connection) with the AP 500.

In step S111, a connection (IP tunnel) is established between the AP 500 and the P-GW 400. As a result, the communication path between the UE 100 and the P-GW 400 is switched from the eNB 200 to the AP 500.

After the offload process, the eNB 200 and the P-GW 400 compare the value of the WLAN stay timer (that is, the WLAN staying time of the UE 100) with the threshold value. When the value of the WLAN stay timer exceeds the threshold value, the eNB 200 and the P-GW 400 discard the held TEID (steps S112 and S113). The following description will proceed under the assumption that the value of the WLAN stay timer does not exceed the threshold value.

In step S114, the UE 100 decides to perform the reoffload process from the AP 500 to the eNB 200.

In step S115, the UE 100 performs the reoffload process from the AP 500 to the eNB 200. The P-GW 400 detects the reoffload process.

In step S116, the P-GW 400 allocates the held TEID to the IP tunnel or the GTP tunnel of the UE 100.

In step S117, the P-GW 400 (or the MME/S-GW 300) transmits the second switching information (steer from WLAN to LTE) and the second message (E-RAB Setup Request) including the retained TEID to the eNB 200. The eNB 200 receives the second message.

In step S118, the eNB 200 stops the WLAN stay timer associated with the TEID included in the second message.

In step S119, when the value of the WLAN stay timer is less than the threshold value, the eNB 200 determines that the ping-pong phenomenon has occurred and changes the determination parameters.

In step S120, the UE 100 and the eNB 200 perform a process of establishing a connection (RRC connection).

In step S121, the UE 100 establishes the connection (RRC connection) with the eNB 200.

In step S122, the connection (IP tunnel) is established between the eNB 200 and the P-GW 400. Accordingly, the E-RAB (the radio bearer and the S1 bearer) is established. Therefore, the communication path between the UE 100 and the P-GW 400 is switched from the AP 500 to the eNB 200.

As described above, according to the first embodiment, the eNB 200 can determine whether or not the ping-pong phenomenon has occurred and optimize the determination parameters in accordance with the occurrence of the ping-pong phenomenon.

### Second Embodiment

Next, a second embodiment will be mainly described in connection with a difference with the first embodiment.

In the first embodiment, the eNB 200 detects the reoffload process on the basis of the second message (E-RAB Setup Request) transmitted from the EPC 20.

On the other hand, in the second embodiment, the eNB 200 detects the reoffload process on the basis of information transmitted from the UE 100.

In detail, in the eNB 200, the LTE radio communication unit 210 receives the second switching information indicating that the UE 100 switches the communication path from the WLAN 50 to the E-UTRAN 10 (that is, the reoffload process) from the UE 100. In response to the reception of the second switching information, the controller 220 ends the measurement of the staying time.

The second switching information is included in a third message transmitted from the UE 100. The third message is a message (RRC Connection Request) for an RRC connection between the UE 100 and the eNB 200 or a message (RRC Connection Reconfiguration Complete) for reconfiguring the RRC connection between the UE 100 and the eNB 200.

Further, the controller 220 holds the identifier associated with the UE 100 after the UE 100 switches the communication path to the WLAN 50. The third message includes the identifier associated with the UE 100. The controller 220 detects that the UE 100 switches the communication path to the eNB 200 on the basis of the held identifier and the identifier included in the third message.

In the second embodiment, the identifier associated with the UE 100 is a cell-radio network temporary identifier (C-RNTI). However, an identifier other than the C-RNTI may be used. The C-RNTI is an identifier which is temporarily allocated by the eNB 200 for the control of the UE 100.

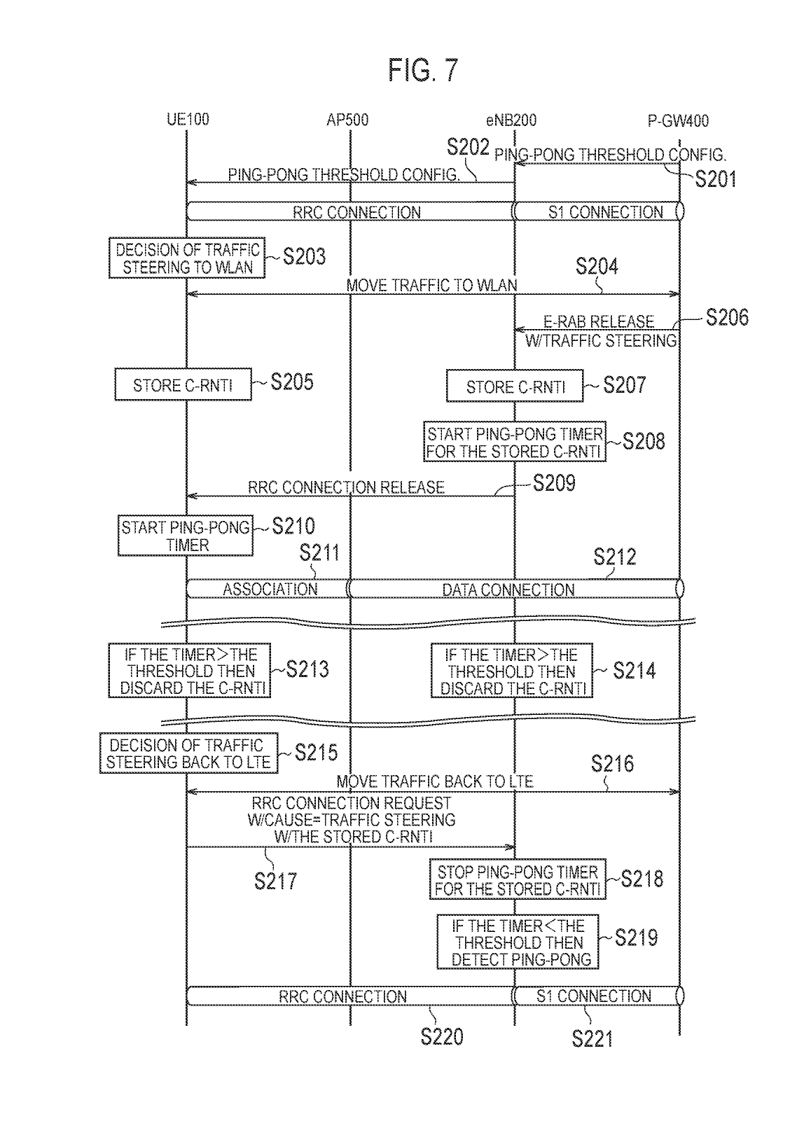

FIG. 7 is a sequence diagram illustrating an operation according to the second embodiment. In the initial state of the present sequence, the communication path is established between the UE 100 and the P-GW 400. In detail, one or more bearers (E-RABs) are established between the UE 100 and the EPC 20 via the eNB 200. Further, the RRC connection (and the radio bearer) is established between the UE 100 and the eNB 200, and the S1 connection (the S1 bearer) is established between the eNB 200 and the EPC 20.

As illustrated in FIG. 7, prior to the present sequence, the P-GW 400 notifies the eNB 200 of the threshold value (the ping-pong threshold) (step S201). The threshold value (the ping-pong threshold) may be set in the eNB 200 from the OAM. However, the process of step S201 is not mandatory and may be omitted. The eNB 200 notifies the UE 100 of the threshold value (the ping-pong threshold) (step S202). The notification of the threshold value to the UE 100 may be give through broadcasting.

In step S203, the UE 100 decides to perform the offload process from the eNB 200 to the AP 500.

In step S204, the UE 100 performs the offload process from the eNB 200 to the AP 500. The P-GW 400 detects the offload process.

In step S205, the UE 100 holds the C-RNTI allocated from the eNB 200 before the offload process.

In step S206, the P-GW 400 (or the MME/S-GW 300) transmits the first message (E-RAB Release Command) including the first switching information (steer from LTE to WLAN) to the eNB 200. The eNB 200 receives the first message. Accordingly, the E-RAB (the radio bearer and the S1 bearer) are released.

In step S207, the eNB 200 holds the C-RNTI that is allocated to the UE 100 before the offload process.

In step S208, the eNB 200 activates the WLAN stay timer. The WLAN stay timer is associated with the C-RNTI held in step S207.

In step S209, the UE 100 releases the RRC connection with the eNB 200. In detail, when the RRC release message is transmitted from the eNB 200 to the UE 100, the UE 100 releases the RRC connection with the eNB 200.

In step S210, the UE 100 activates the WLAN stay timer. In the second embodiment, the WLAN stay timer of the UE 100 is used to specify the period during which the UE 100 should hold the C-RNTI. Step S210 may be performed at the same time as step S205.

In step S211, the UE 100 establishes the connection (WLAN connection) with the AP 500.

In step S212, the connection (IP tunnel) is established between the AP 500 and the P-GW 400. Accordingly, the communication path between the UE 100 and the P-GW 400 is switched from the eNB 200 to the AP 500.

After the offload process, the UE 100 and the eNB 200 compare the value of the WLAN stay timer (that is, the WLAN staying time of the UE 100) with the threshold value. When the value of the WLAN stay timer exceeds the threshold value, the UE 100 and the eNB 200 discard the held C-RNTI (steps S213 and S214). The following description will proceed under the assumption that the value of the WLAN stay timer does not exceed the threshold value.

In step S215, the UE 100 decides to perform the reoffload process from the AP 500 to the eNB 200.

In step S216, the UE 100 performs the reoffload process from the AP 500 to the eNB 200.

In step S217, the UE 100 transmits the third message (RRC Connection Request) for requesting the establishment of the RRC connection with the eNB 200 to the eNB 200. The third message includes the second switching information (steer from WLAN to LTE) and the C-RNTI held in the UE 100. The eNB 200 receives the third message.

In step S218, the eNB 200 stops the WLAN stay timer associated with the C-RNTI included in the third message.

In step S219, when the value of the WLAN stay timer is less than the threshold value, the eNB 200 determines that the ping-pong phenomenon has occurred and changes the determination parameters.

In step S220, the UE 100 and the eNB 200 establish the connection (RRC connection).

In step S221, the connection (IP tunnel) is established between the eNB 200 and the P-GW 400. Accordingly, the E-RAB (the radio bearer and the S1 bearer) is established. Therefore, the communication path between the UE 100 and the P-GW 400 is switched from the AP 500 to the eNB 200.

As described above, according to the second embodiment, similarly to the first embodiment, the eNB 200 can determine whether or not the ping-pong phenomenon has occurred and optimize the determination parameters in accordance with the occurrence of the ping-pong phenomenon.

### Third Embodiment

Next, a third embodiment will be mainly described in connection with a difference with the first embodiment.

In the first embodiment, the eNB 200 determines whether or not the ping-pong phenomenon has occurred.

On the other hand, in the third embodiment, the P-GW 400 determines whether or not the ping-pong phenomenon has occurred.

In detail, the controller 410 of the P-GW 400 detects that the UE 100 communicating with the EPC 20 via the eNB 200 provided in the E-UTRAN 10 switches the communication path from the eNB 200 to the WLAN 50 (that is, the offload process) and starts the measurement of the staying time in which the UE 100 stays in the WLAN 50 in accordance with the detection.

Then, when the controller 410 detects that the UE 100 switches the communication path from the WLAN 50 to the eNB 200 (that is, the reoffload process), the controller 410 ends the measurement of the staying time and notifies the eNB 200 of information based on the staying time. The information based on the staying time is information indicating that the ping-pong phenomenon has occurred. Alternatively, the information based on the staying time may be the staying time or an index value thereof.

The operation sequence according to the third embodiment is one in which the operation sequence illustrated in FIG. 6 is partially modified. In detail, the P-GW 400 performs the process of steps S118 and S119 in place of the eNB 200, and then notifies the eNB 200 of the information based on the staying time to. The eNB 200 determines that the ping-pong phenomenon has occurred on the basis of the information based on the staying time, and changes the determination parameters. The information based on the staying time may be included in the second message (E-RAB Setup Request).

Thus, according to the third embodiment, it is possible to optimize the determination parameters in accordance with the occurrence of the ping-pong phenomenon, similarly to the first and second embodiments.

### Other Embodiments

Although not specifically mentioned in the first to third embodiments, each of the first switching information (steer from LTE to WLAN) and the second switching information (steer from WLAN to LTE) may be stored in a cause field of the corresponding message. The cause field is a field in which information indicating the cause of the message is stored.

Although not specifically mentioned in the first to third embodiments, a program causing a computer to perform each process performed by any one of the UE 100 or the eNB 200 may be provided. Further, the program may be recorded on a computer readable medium. By using a computer-readable medium, it is possible to install the program in the computer. Here, the computer readable medium on which the program is recorded may be a non-transitory recording medium. The non-transitory recording medium is not particularly limited but may be a recording medium such as a CD-ROM or a DVD-ROM.

Alternatively, a chip configured with a memory that stores a program of performing each process performed by any one of the UE 100 and the eNB 200 and a processor that executes a program stored in the memory may be provided.

The first to third embodiments have been described under the assumption that a scheme of the mobile communication scheme is LTE. However, it may be a scheme other than LTE such as universal mobile telecommunications system (UMTS) or global system for mobile communications (GSM).

[Additional Description]

1. Introduction

The WLAN/3GPP Radio Interworking WI was closed and the RAN assistance parameters for the traffic steering were approved to be introduced. In the Multi-RAT Joint Coordination SI, RAN3 has started discussion on complementary solutions for the traffic steering mechanism defined in RAN2, wherein use cases of the estimation of UE throughput in WLAN and the parameters exchanged from the WLAN to 3GPP nodes have been identified.

On the other hand, further use cases which take into account UE mobility, i.e. mobility robustness optimization (MRO) involving WLAN have been interested in.

In this additional description we discuss the necessary of the MRO involving WLAN to optimize the RAN assistance parameters.

2. Discussion

2.1. Needs for Further Use Cases of Coordination Involving WLAN

The RAN assistance parameters are used in the UE for the decision of traffic steering between E-UTRAN and WLAN, and the parameters are configured by the eNB. Although the same mechanisms were introduced for UTRAN, the following consideration assumes the RAN assistance parameter for E-UTRAN in order to simplify the discussion.

Table 1 shows a summary of the RAN assistance parameters with some categorizations and possible solutions for the eNB to configure the parameters with appropriate values.

Note that the OAM to provide (at least initial) the parameter is baseline but it's omitted in Table 1.

To optimize UE throughput and cell load, RSRP and RSRQ thresholds are used. It is assumed that these thresholds were determined based on load status in the eNB itself.

Observation 1: RSRP and RSRQ thresholds may be determined by the condition of the eNB itself.

The other thresholds are available for BSS load, WAN metrics and Beacon RSSI, which are used to evaluate throughput and/or load status in WLAN. These thresholds are used for very similar purpose to RSRP and RSRQ thresholds, i.e. for optimization of UE throughput before/after the traffic steering. Therefore, the developing solutions for the estimation of UE throughput in WLAN may be re-used for the determination of the thresholds.

Observation 2: BSS load, WAN metrics and Beacon RSSI thresholds can be possibly determined by the developing solutions for the estimation of UE throughput in WLAN.

Observation 3: RAN assistance parameters for throughput and load optimization may be automatically determined by means of the existing information or developing solutions.

As for mobility optimization purpose, the RAN assistance parameter has Tsteering_{WLAN}, which is similar timer to the existing Time To Trigger (TTT) for E-UTRAN measurements and is common view in RAN2 to use it for mobility purpose. If during Tsteering_{WLAN}, which is adjustable between 0 and 7 [s], the evaluation fulfills the criteria based on the thresholds for RSRP, RSRQ, BSS load, WAN metrics and/or Beacon RSSI, the UE decide to inform higher layer of the traffic steering opportunity, which is a bare bones in the Rel-12 mechanism defined, meanwhile it has discussed that it should be noted that timer value should be long enough in order that frequent changes of access network could be avoided. Obviously, the most suitable threshold to be configured to Tsteering_{WLAN} is different under different deployments. Therefore, it should be optimized depending on the practical deployments. However, current use case in MRJC cannot determine the threshold because it just estimates the UE throughput in WLAN, so at this point the threshold has no other choice to be configured with a fixed value provided by OAM. Considering a large amount of WLAN APs are being deployed day by day, the problem is how to maintain the optimal thresholds following the changes in WLAN radio conditions. Therefore, the problem should be solved by an autonomous mechanism to update the thresholds, i.e. MRO involving WLAN.

Proposal 1: We should Agree to Capture the Mobility Robustness Optimization involving WLAN as a new use case.

With regard to WLAN identifiers, i.e. BSSID, ESSID and HESSID of the AP, automatic collection mechanisms, e.g. ANR involving WLAN have been interested in.

Table 1 shows RAN assistance parameters.

TABLE 1

| Main focus | RAN assistance parameters | | Possible solutions |
|---|---|---|---|
| Throughput and | RSRP | To WLAN; | Load information in |
| load | | Thresh_{ServingOffloadWLAN,LowP} | eNB itself may |
| | | From WLAN; | determine the |
| | | Thresh_{ServingOffloadWLAN,HighP} | parameters. |
| | | | (RAN2 assumption) |
| | RSRQ | To WLAN; | |
| | | Thresh_{ServingOffloadWLAN,LowQ} | |
| | | From WLAN; | |
| | | Thresh_{ServingOffloadWLAN,HighQ} | |
| | BSS load | To WLAN; | Information obtained |
| | (Channel | Thresh_{ChUtilWLAN,Low} | for estimation of |
| | utilization) | From WLAN; | throughput in WLAN |
| | | Thresh_{ChUtilWLAN,High} | may be re-used. |
| | WAN | To WLAN; | |
| | metrics | Thresh_{BackhRateDLWLAN,High} | |
| | (Backhaul | Thresh_{BackhRateULWLAN,High} | |
| | rate) | From WLAN; | |
| | | Thresh_{BackhRateDLWLAN,Low} | |
| | | Thresh_{BackhRateULWLAN,Low} | |
| | Beacon | To WLAN; | |
| | RSSI | Thresh_{BeaconRSSIWLAN,High} | |
| | | From WLAN; | |
| | | Thresh_{BeaconRSSIWLAN,Low} | |
| Mobility | Time | Tsteering_{WLAN} | None so far. |
| | interval for | | (May need MRO-like |
| | decision | | mechanism.) |
| General | SSID, | WLAN identifiers | None so far. |
| | BSSID, | | (May need ANR-like |
| | HESSID | | mechanism) |

Note:
OAM to provide (at least initial) the parameter is baseline but it's omitted in Table 1.

2.2. RAN Assistance Parameter Adjustment for Mobility Robustness

As mentioned in section 2.1, Tsteering_{WLAN} is essential to optimize the motility robustness. Obviously, if taking only the offloading efficiency into account then Tsteering_{WLAN} should be configured with the minimum value (0 [s]), but it may cause mobility problems such as ping-pong steering. Therefore, in order to provide the better QoE, Tsteering_{WLAN} needs to be configured with a balanced value between offloading efficiency and ping-pong avoidance.

Another aspect to be considered for UE mobility is the variance of radio conditions, as well-known. Normally the thresholds for radio condition evaluation has a hysteresis between in- and out-of-conditions, and RAN assistance parameters also have two thresholds for such purpose. For example, the hysteresis of RSRP thresholds can be denoted as (Thresh_{ServingOffloadWLAN,HighP}−Thresh_{ServingOffloadWLAN,LowP}) [dB]. Needless to say, the hysteresis configured with radio condition-related RAN assistance parameters will affect the network performances along with UE mobility.

Proposal 2: If the proposal 1 is acceptable, we should agree MRO involving WLAN takes into account the optimization of Tsteering_{WLAN} and/or hysteresis of the thresholds for RSRP, RSRQ and Beacon RSSI.

2.3. Issues Expected to be Solved by MRO Involving WLAN

The existing MRO for E-UTRAN has RLF INDICATION and HANDOVER REPORT, which can be used to detect Too Early HO, Too Late HO and HO to Wrong Cell. In consideration for MRO involving WLAN, a different point from the existing MRO is no relation to RLF, i.e. RLF does not depends on whether the traffic steering failure to/from WLAN.

However, Too Early Steering from E-UTRAN to WLAN and Too Late Steering from WLAN to E-UTRAN may be a problem for similar reason, i.e. if the UE does not decide the traffic steering even though the UE is no longer provided sufficient throughput by a radio access network (E-UTRAN or WLAN), the QoE of the UE may be severely impacted.

Therefore, we should consider solutions to avoid such wrong traffic steering. Although it's still FFS, it can be considered as a possible solution to monitor UE throughput in WLAN after traffic steering.

Proposal 3: we should consider how to detect throughput degradation before/after traffic steering.

The other aspect to be considered is ping-pong avoidance. For example, if the RAN assistance parameters for traffic steering to WLAN and those for traffic steering from WLAN are not aligned well, i.e. wrong hysteresis is configured, the UE may decide to steer traffic back to E-UTRAN immediately after traffic steering to WLAN. Such ping-pong steering between E-UTRAN and WLAN may result in more QoE degradations than that between E-UTRAN cells, because the traffic steering has much latency than HO. Therefore, RAN3 should consider how to detect ping-pong steering. Although it's still FFS, a possible solution may be considered with the enhanced UE history information, if the eNB has a means to know which UEs are steered to/back from WLAN.

Proposal 4: we should consider how to detect ping-pong steering between E-UTRAN and WLAN.

### INDUSTRIAL APPLICABILITY

The present invention is useful in communication fields.

1. A base station provided in a mobile communication network, comprising:
a network communication unit configured to receive, from an evolved packet core (EPC), first switching information indicating that a radio terminal switches a communication path with the EPC from the mobile communication network to a wireless LAN; and
a controller configured to start measurement of a staying time in which the radio terminal stays in the wireless LAN, in response to reception of the first switching information.

2. The base station according to claim 1,
wherein the first switching information is included in a first message transmitted from the EPC, and
the first message is a message for giving an instruction to release one or more bearers established between the radio terminal and the EPC via the base station.

3. The base station according to claim 1,
wherein the network communication unit is configured to receive, from the EPC, second switching information indicating that the radio terminal switches the communication path from the wireless LAN to the mobile communication network, and
the controller is configured to end the measurement of the staying time in response to reception of the second switching information.

4. The base station according to claim 3,
wherein the second switching information is included in a second message transmitted from the EPC, and
the second message is a message for requesting establishment of one or more bearers between the radio terminal and the EPC via the base station.

5. The base station according to claim 4,
wherein the controller is configured to hold an identifier associated with the radio terminal after the radio terminal switches the communication path to the wireless LAN,
the second message includes an identifier associated with the radio terminal, and
the controller is configured to detect that the radio terminal switches the communication path to the mobile communication network on the basis of the held identifier and the identifier included in the second message.

6. The base station according to claim 1, further comprising,
a radio communication unit configured to receive, from the radio terminal, second switching information indicating that the radio terminal switches the communication path from the wireless LAN to the mobile communication network, and
the controller is configured to end the measurement of the staying time in response to reception of the second switching information.

7. The base station according to claim 6,
wherein the second switching information is included in a third message transmitted from the radio terminal, and
the third message is a message for establishing an RRC connection between the radio terminal and the base station or a message for reconfiguring an RRC connection between the radio terminal and the base station.

8. The base station according to claim 7,
wherein the controller is configured to hold an identifier associated with the radio terminal after the radio terminal switches the communication path to the wireless LAN,
the third message includes an identifier associated with the radio terminal, and
the controller is configured to detect that the radio terminal switches the communication path to the mobile communication network on the basis of the held identifier and the identifier included in the third message.

9. The base station according to claim 3,
wherein the network communication unit is configured to receive a threshold value from the EPC,
the controller is configured to compare the measured staying time with the threshold value, and to decide parameters when the staying time is less than the threshold value, and
the parameters are parameters used for determining whether or not the radio terminal switches the communication path from the mobile communication network to the wireless LAN.

10. An apparatus constituting an evolved packet core (EPC), comprising:
a controller configured to start measurement of a staying time in which a radio terminal stays in a wireless LAN when the controller detects that the radio terminal switches a communication path with the EPC from a mobile communication network to the wireless LAN.

11. The apparatus according to claim 10,
wherein when the controller detects that the radio terminal switches the communication path from the wireless LAN to the mobile communication network, the controller is configured to end the measurement of the staying time, and to give a notification of information based on the staying time to a base station constituting the mobile communication network.

12. A radio terminal configured to
transmit, to a base station constituting a mobile communication network, switching information indicating that a communication path with an evolved packet core (EPC) is switched from a wireless LAN to the mobile communication network,
wherein the switching information is included in a message for establishing an RRC connection between the radio terminal and the base station or a message for reconfiguring an RRC connection between the radio terminal and the base station.
